(19) United States
(12) Patent Application Publication
(10) Pub. No.: US 2002/0037135 A1
(43) Pub. Date: Mar. 28, 2002

(54) Fiber grating circuit and a method of measuring grating dispersion

(76) Inventors: Ahmad K. Atieh, Nepean (CA); Ilya Golub, Nepean (CA)

Correspondence Address: JDS Uniphase Corporation, Intellectual Property Dept., Suite 201, 1187 Bank Street, Ottawa, ON, K1S 3X7, CA

(21) Appl. No.: 09/907,670

(22) Filed: Jul. 19, 2001

(30) Foreign Application Priority Data
Sep. 26, 2000 (CA) 2,322,552

(51) Int. Cl. G02B 6/34

(52) U.S. Cl. 385/37; 385/27; 385/39

(57) ABSTRACT

An optical circuit has a loop mirror coupled to a 3-dB coupler, with a chirped fiber Bragg grating coupled in the mirror loop. When a beam of light from a broadband light source is launched into the circuit, the circuit functions as a tunable notch filter or as a bandpass filter depending on which output port of the coupler is used to monitor the response. An interference fringe pattern generated in the response of the circuit enables to determine dispersion of the chirped Bragg grating.

### REFERENCE TO RELATED APPLICATIONS

This application claims priority of Canadian patent application No. 2,322,552 filed Sep. 26, 2000.

### FIELD OF THE INVENTION

This invention relates to a fiber grating circuit, more specifically an optical loop with fiber gratings, and to a method of measuring dispersion of such fiber gratings.

### BACKGROUND OF THE INVENTION

Fiber Bragg gratings (FBGs) have been in use for a number of years. Chirped fiber Bragg gratings also have many applications in optical telecommunication systems such as dispersion compensation, pulse shaping in fiber lasers, and creating stable continuous-wave and tunable mode-locked external cavity semiconductor lasers. One of the important parameters that describe FBGs is the dispersion across the grating bandwidth. Some of the methods used to measure the dispersion of FBGs are described in “HP 860337B Chromatic Dispersion (CD) Test Solution, Test and Measurement Catalog 2000”.

Tunable narrow-band optical filters have many applications in wavelength division multiplexing (WDM) systems, optical spectrum analysis and subcarrier demultiplexing. Common commercial available filters includes fiber Bragg gratings (FBGs), thin-film dielectric interference filters, Fabry-Perot filters, and phased-array waveguides.

Following the development of FBGs, a number of all-fiber comb filters based on fiber gratings have been proposed. They include a sampled Bragg grating, cascaded long-period gratings, wide-band chirped grating Fabry-Perot resonator (G. E. Town et al., IEEE Photon. Technol. Lett., vol.. 7, pp. 78-80, January 1995) and fiber Bragg grating Michelson interferometer.

In a paper “Fiber Grating Sagnac Loop and Its Multiwavelength-Laser Application, X. Shu et al. (IEEE Photonics Technology Letters, Vol. 12, No. 8, August 2000) describe a filter based on a Sagnac interferometer with a FBG asymmetrically located in its fiber loop.

S. Havstad et al, Loop Mirror Filters based on saturable-gain or-absorber gratings, Optics Letters Vol. 24, No. 21, Nov. 1, 1999, describe tunable bandpass and notch filters using a loop mirror configuration with saturable absorber or gain element. The saturable element is realized from an erbium-doped fiber (EDF) or from counter-propagating pumping of an EDF pump at 980 nm. The tuning mechanism is achieved by tuning the pumping wavelength.

R. H. Qu et al., IEEE Photonics Technology Letters, Vol. 12, No. 10, October 2000, describe a configurable wavelength-selective switch based on a fiber grating and fiber loop mirror, the switch usable for routing or demultiplexing in dense wavelength division multiplexing networks.

### SUMMARY OF THE INVENTION

In accordance with one aspect of the invention, there is provided a method for measuring chromatic dispersion and polarization mode dispersion (PMD), of a chirped Bragg grating, the method comprising:

coupling a chirped fiber Bragg grating into a loop mirror comprising

a waveguide loop and

a coupler having at least an input port, optionally an output port, a first loop port and a second loop port, the waveguide loop connected to the first loop port and to the second loop port,

launching a light beam into the input port to cause an interference fringe pattern due to a chirp of the grating,

calculating a dispersion of the grating based on the fringe pattern.

The interference fringe pattern may be created at the output port of the coupler. The light beam may be launched from a broadband light source or from a tunable laser source. In accordance with another aspect of the invention, there is provided an optical circuit useful as a tunable optical filter, the circuit comprising,

a coupler having at least an input port, a first loop port and a second loop port,

a waveguide loop coupled to the first and second loop port,

a chirped fiber grating coupled in the loop, and

a source of light coupled to the input port of the coupler.

The fiber grating may be a chirped fiber Bragg grating. The chirp of the grating may preferably be non-linear.

It will be understood that a plurality of adjacent Bragg gratings disposed on the same waveguide will serve the same function for the purpose of the invention as long as the period of the grating or gratings in combination changes in a continuous or quasi-continuous manner and so does the response. Chirped fiber Bragg gratings can be formed either with continuously changing period or in such a way that their period changes by small steps with each step typically being about 100 μm and with a about. 0.01 nm change in period between the steps.

The coupler may have an output port and the input port may function as an input/output port. The circuit can function as a bandpass filter and/or as a notch filter.

### BRIEF DESCRIPTION OF THE DRAWINGS

The invention will be explained in more detail by way of the following description in conjunction with the drawings in which:

FIG. 1 is a schematic representation of a tunable filter circuit according to the invention,

FIG. 2 is a diagram representing measured interference patterns for two different linearly chirped FBGs,

FIG. 3 is a diagram of calculated dispersion of linearly chirped FBG using interference fringing pattern, and

FIG. 4 is a diagram of the spectral response of the filter of the invention.

### DETAILED DESCRIPTION OF EMBODIMENTS OF THE INVENTION

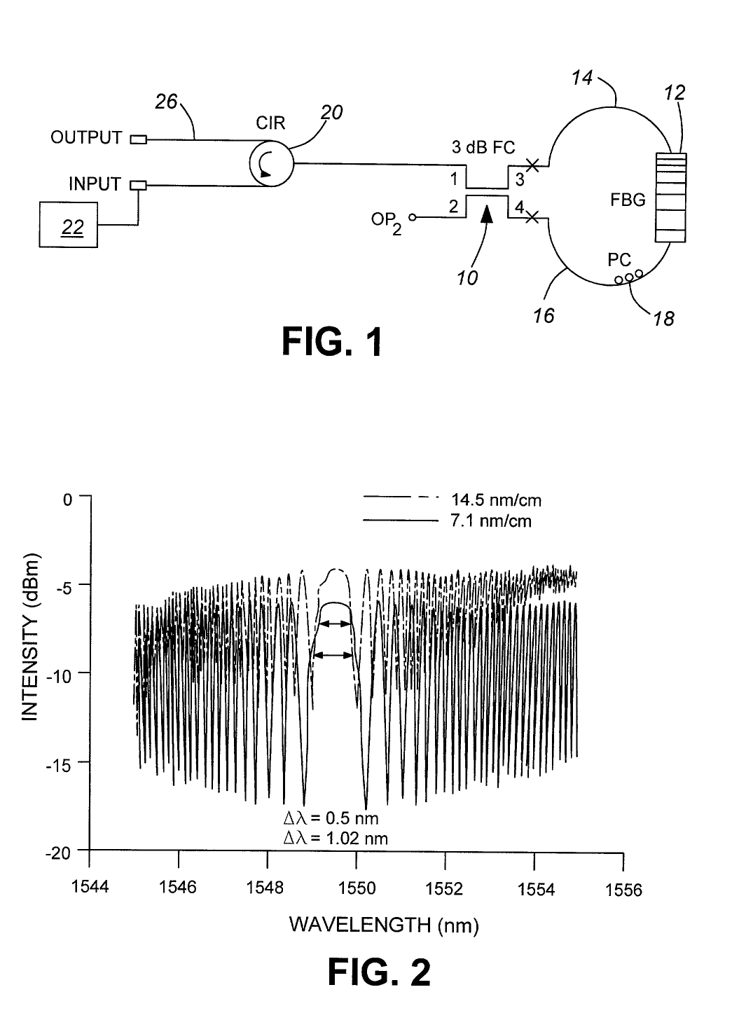

Referring to FIG. 1, an exemplary filter circuit of the invention has a 3-dB fiber coupler 10 spliced to the terminals of a chirped fiber Bragg grating 12 using two lengths of a single-mode optical fiber 14, 16, to form a loop. The FBG 12 is placed approximately in the center of the loop. At a given temperature, the center wavelength of the fringe pattern is automatically chosen in such a way that the clockwise and counterclockwise reflected waves experience the same loop arm length. A polarization controller 18 is placed in the loop to adjust the contrast of the interference pattern at a loop output terminal. The coupler 10 has four ports 1-4, ports 3 and 4 for coupling the loop, port 1 being an input/output port and port 2 being an output port. A circulator 20 is coupled to the input/output port 1 to direct light into and from the loop. The circuit has a first output port OP₁ and a second output port OP₂ coupled to the port 2 of the coupler 10. A broadband light source 22 is coupled to the circulator 20 via an input waveguide 24 to launch a light beam into the circuit. A signal reflected from the loop is retrieved either at the alternative output port OP₂ or at an output port 26 of the circulator 20. The circulator has more than 45-dB isolation and 0.8-dB insertion loss between its ports.

The use 3-dB (50-50) coupler is optimal, but the system will work with a coupler having a somewhat different split ratio.

The output of the circuit has bandpass filter characteristics at input/output port OP₁ (port 1 of the coupler 10) and complementary notch filter characteristics at the other output OP₂. The center wavelength of the filter represents the center wavelength of the chirped FBG if the grating is placed in the loop center. The filter center wavelength can be tuned by either changing the arm length difference in the loop or by controlling the temperature of the grating. Thus, the filter has built-in a process of choosing the center wavelength at a certain temperature where the clockwise and counter-clockwise waves reflected from the grating experience the same loop arm length.

Light launched into the loop is split into the two arms 14, 16 of the loop and is reflected from the FBG at different positions based on the chirp of the grating. The difference in path length of the back-reflected light of the chirped grating at different wavelengths creates a fringe pattern at the device output. The number of fringes and the wavelength separation between the fringes have the necessary information to calculate the group delay and dispersion of the grating. The reflected light from the center wavelength of the chirped FBG, in both directions of the loop, propagates through equal length if the grating is placed in the loop center. For a given chirped FBG with chirp dλ/dz and dispersion D at wavelength λ, the number of fringes N in an incremental bandwidth Δλ is given by

N=cDΔλ²/λ² (1)

where c is the speed of light and z is a position along the length of the grating.

The dispersion of the chirped grating is given by

D=(λ²/2c)d²N/d(Δλ)² (2)

While the group delay τ is

τ=(λ²/c)dN/d(Δλ) (3)

In the filter aspect of the invention, the bandpass filter performance and the complementary notch filter performance, observed at outputs OP₁ , and OP₂ respectively, will be discussed. FIG. 2 illustrates bandpass filter response i.e. measured interference pattern at output terminal OP₁ for two linearly chirped gratings with chirp 14.5 nm/cm (lower profile) and 7.1 nm/cm (upper profile). The bandpass filter 3-dB bandwidth □ of the upper interference pattern is 0.8 nm and the corresponding 3-dB bandwidth of the lower pattern is 1.02 nm. Considering the lower profile for further discussion, the grating 3-dB bandwidth is 20.6 nm with center wavelength at 1550.1 nm. The measured bandpass filter response has 3-dB bandwidth of approximately 1.0 nm with flat transmission band of 0.54 nm. The measured interference pattern has many fringes due to interference between light reflected in both directions of the loop from different locations of the chirped grating. The number of fringes and the bandwidth of the center fringe depend on the chirp of the grating as shown in FIG. 2. The number of fringes is calculated using formula (1) above.

The larger the chirp parameter (in nm/cm of the grating), the less dense the fringes produced in the interference pattern. On the other hand, the smaller the chirp, the narrower the filter bandwidth (the central area of the profiles). For an effective filter, these are contradictory phenomena. To achieve a desirable filter profile, with a narrow bandpass width (e.g. in the range 0.5-0.8 nm) and fringes as distant as possible from the bandpass, it has been found that the above-discussed contradiction can be at least partially overcome by using at least one FBG of non-linear chirp, e.g. with smaller chirp in the center of the grating and larger chirp farther from the center. For example, a FBG with a X³ (cubic) chirp profile may satisfy the requirements for a good bandpass/notch filter.

Turning now to the notch filter aspect of the invention, FIG. 4 shows a notch filter characteristics measured at output OP₂ for a chirped FBG with 3-dB bandwidth of approximately 0.8 nm. The contrast of the notch filter is more than 7 dB and 3-dB bandwidth from the notch is approximately 0.04 nm. The same argument, about nonlinear chirp requirement applies to the notch filter output. The important requirements needed for these filters to be used in telecommunication applications are: the fringes should be far from the filter bandpass, the bandpass width should be narrow, and the contrast of the filter should be as large as possible.

The number of fringes and the wavelength separation between the fringes are insensitive to temperature variations. The only parameter that varies with temperature is the center wavelength of the interference pattern.

By controlling the state of polarization of the light in the loop using the polarization controller, it is possible to change the filter characteristics from bandpass to notch at the same output terminal. This implies the possibility to control the attenuation of the light at the center wavelength.

As discussed above, the number of fringes and wavelength separation between fringes are calculated from FIG. 2. The dispersion of the chirped FBG is evaluated using equation (2).

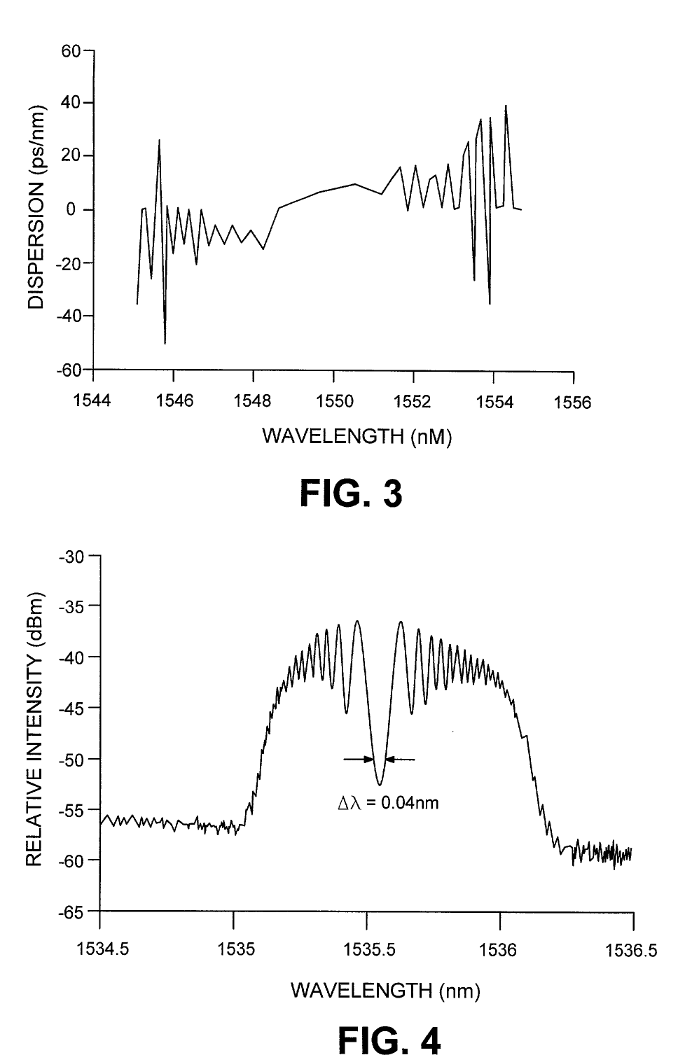

FIG. 3 illustrates the calculated dispersion of linearly chirped FBG with chirp of 14.5 nm/cm. The 3-dB bandwidth of the grating is 20.6 nm, and the center wavelength is 1550.1 nm. It is noted that the center wavelength of the measured interference pattern in FIG. 2 is shifted from 1550.1 nm. This may be due to either placing the grating off the center in the loop and/or drifting of the grating center wavelength due to temperature variation because the FBG under test was not in a thermally compensated package. A commonly used estimate of dispersion (ps/nm) of linearly chirped FBG is given by equation

D˜100(dλ/dz)⁻¹ (4)

Using equation (4), the estimated average dispersion across the FBG under test was 6.9 ps/nm. The calculated dispersion using the proposed scheme is 7.2 ps/nm. The dispersion measurement shown in FIG. 3 was compared with commercial dispersion measurement performed using HP86037B Chromatic Dispersion test equipment, available from Hewlett Packard. A very good agreement was achieved for one half of the grating bandwidth because the HP test equipment does not show detailed features of the other half of the FBG bandwidth, which requires performing the measurement from the other side of the grating. However, the measured dispersion of one half of the grating bandwidth using loop mirror scheme has an opposite sign due to the way the light propagated through the grating in the loop. This technique is recommended for chirped FBGs for which enough fringes in the interference pattern are generated to perform the dispersion calculation.

To measure PMD for chirped FBG using loop mirror scheme one has to measure first the group delay for different states of polarization and then using one of the available algorithms calculate the differential group delay (PMD). For example it is possible to adjust the state of polarization (SOP) of light launched into the loop to the slow axis and measure the group delay from the fringe pattern. Then do the same measurement for the SOP adjusted to the fast axis and calculate the difference between the two group delays, i.e. the PMD.

While the present invention has been described and illustrated herein with reference to the preferred embodiments thereof, it will be understood by those skilled in the art that various changes in form and detail may be made therein without departing from the spirit and scope of the invention.

What is claimed is:

1. A method for measuring chromatic dispersion and PMD of a chirped Bragg grating, the method comprising:
coupling a chirped fiber Bragg grating into a loop mirror comprising
a waveguide loop and
a coupler having an input port, a first loop port and a second loop port, the waveguide loop connected to the first loop port and to the second loop port,
launching a light beam into the input port to cause an interference fringe pattern due to a chirp of the grating,
calculating a dispersion of the grating based on the fringe pattern.

2. The method of claim 1 wherein the dispersion is calculated from the formula
D=(λ²/2c)d²N/d(Δλ)².
(where λ is a wavelength and Δλ is incremental bandwidth and wherein the number of fringes, N, is given by the formula
N=cDΔλ²/λ²
where c is the speed of light and z is a position along the length of the grating.

3. The method of claim 1 wherein the grating has a chirp (dλ/dz)

4. An optical circuit comprising
a coupler having at least an input port, a first loop port and a second loop port,
a waveguide loop coupled to the first and second loop port,
a chirped fiber grating coupled in the waveguide loop, and
a source of light coupled to the input port of the coupler.

5. The optical circuit of claim 4 wherein at least one chirped fiber grating has a nonlinear chirp profile.

6. The circuit of claim 5 wherein the chirp profile is an x³ profile.

7. The circuit of claim 4 further comprising an output port, wherein the input port serves as an input/output port

8. The circuit of claim 4 which performs as a bandpass filter upon launching a beam of light into the waveguide loop.

9. The circuit of claim 4 which performs as a notch filter upon launching a beam of light into the waveguide loop.

10. The circuit of claim 4 wherein the chirped grating comprises a number of adjacent gratings exhibiting in combination a continuous or quasi-continuous wavelength response.
